(19) United States
(12) Patent Application Publication
(10) Pub. No.: US 2005/0245201 A1
(43) Pub. Date: Nov. 3, 2005

(54) Front-end topology for multiband multimode communication engines

(75) Inventors: Juha Ella, Halikko (FI); Tero Ranta, Turku (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/836,123

(22) Filed: Apr. 30, 2004

(51) Int. Cl. H04B 1/44; H04B 1/06

(52) U.S. Cl. 455/78; 455/552.1; 455/272

(57) ABSTRACT

The combination of filters and switches is used to solve the non-linearity problems in GSM/W-CDMA transceiver front-end wherein one common antenna is used for both the GSM mode and the W-CDMA mode. In particular, separate Rx/Tx paths and switches in the Rx paths are used to provide cross-band isolation between bands. All of the switches in the transceiver are disposed after the filters in that no switches are disposed between the filters and the antenna. Furthermore, bandpass filters are matched to one common node even if they are only disconnected at the output as long as the impedance at the output can be controlled.

### CROSS REFERENCES TO RELATED APPLICATIONS

The present application is related to U.S. patent applications with Ser. Nos. 10/688,181, 10/688,275 and 10/688,807, all filed on Oct. 17, 2003, and assigned to the assignee of the present application. The present invention is also related to U.S. patent application Ser. No. ______, Docket No. 944-003.230, assigned to the assignee of the present invention, and filed even date herewith.

### FIELD OF THE INVENTION

The present invention relates generally to front-end topology and, more particularly, to front-end arrangement for multiband and/or multimode mobile cellular handset electronics.

### BACKGROUND OF THE INVENTION

The term “front-end”, as used in this disclosure, means the components and functions between the antennas and the power amplifiers or RF-ASIC (radio frequency application specific integrated circuit), but some front-end modules may also include power amplifiers. The front-end in multiband, multimode engines, especially those that are designed to meet the requirement of MIMO (multiple-input, multiple-output) and/or diversity functionality, is usually very complex in construction and design. Because the front-end generally comprises many switches, it consumes a significant amount of electrical current and needs many control lines. MIMO functionality is required in new and future mobile terminals and, initially, Rx MIMO is prioritized because the downlink data rate is more important than the uplink counterpart in mobile communications. Essentially, Rx MIMO requires more than one Rx path to be provided on a particular band of operations. The outputs of these paths are then monitored and combined to give an enhanced data rate. The antenna fed to each of these paths is independent from each other.

Currently, a GSM/W-CDMA multimode engine is designed to have a separate GSM antenna and a separate W-CDMA antenna. A W-CDMA antenna is connected to a duplexer that has a passband filter for both the Rx and Tx paths of the W-CDMA mode. The GSM antenna is connected to an antenna switch module that typically first separates the 1 GHz frequencies from the 2 GHz bands using a diplexer or the like. The Rx and Tx paths of each frequency range are then separated by switches (usually PIN diodes). The antenna switch module often also includes harmonic filtering for the power amplifier outputs and may include surface-acoustic wave (SAW) filters to provide filtering for the Rx paths. A typical block diagram of a typical front-end is shown in FIGS. 1a and 1b. As shown in FIG. 1a, the GSM module includes four sections: 1 GHz GSM Rx section, 1 GHz GSM Tx section, 2 GHz GSM Rx section and 2 GHz GSM Tx section. The 1 GHz GSM Rx section includes an 869-894 MHz Rx path 110, and the 925-960 MHz Rx path 130. The 1 GHz GSM Tx section, collectively denoted as path 150, includes two frequency bands of 824-849 MHz and 880-905 MHz. The 869-894 MHz Rx path 110 includes a filter 116 connected between ports 112 and a balun 122. The 925-960 MHz Rx path 130 includes a filter 136 connected between ports 132 and a balun 142. The balun functionality can be incorporated into the filters 116 & 136 depending on the filter technology. The Rx paths 110 and 130 are joined at a common node 910. These Rx paths are also joined with the port 152 of the 824-849/880-905 MHz Tx path 150 at a node 912 via a matching element 80. Here PIN diodes 42 and 44 are used for Tx-Rx switching. Alternatively, other switch technologies can be also used, e.g. CMOS or GaAs p-HEMTs (Pseudomorphic High Electron Mobility Transistor). However, by using the CMOS and p-HEMT switches, the arrangement of biasing and matching elements will be slightly modified.

The 2 GHZ Rx section includes a 1805-1880 MHz Rx path 220, commonly referred to as the 1800GSM mode, and the 1930-1990 MHz Rx path 240, commonly referred to as the 1900GSM mode. The 2 GHz GSM Tx section, collectively denoted as path 260, includes two frequency bands of 1710-1758 MHz and 1850-1910 MHz. The 1805-1880 MHz Rx path 220 includes a filter 226 connected between ports 222 and a balun 232. The 1930-1990 MHz Rx path 240 includes a filter 246 connected between ports 242 and a balun 252. The Rx paths 220 and 240 are joined at a common node 914 with matching circuits or devices 84, 86. These Rx paths are also joined with the port 262 of the 1710-1758/1850-1910 MHz Tx path 260 at a node 916 via a matching element 82. Here PIN diodes 46, 48 are used for Tx-Rx switching. The 1 GHz and 2 GHZ parts are connected to a common feed point 918 of the GSM antenna 10 through a diplexer 30, which comprises harmonic filters 32, 34 for the Tx paths 150 and 260.

In FIG. 1b, the W-CDMA module has two paths: a 2110-2170 MHz Rx path 320 and a 1920-1980 MHz Tx path 340. The Rx path 320 includes a filter 326 connected between ports 322 and a balun 332. However, the balun can also be after the filter and external to the duplexer. The 1920-1980 Tx path 340 has a passband filter 346 and a port 342. The Rx path 320 is joined with the Tx path 340 at a node 920 and a common W- CDMA antenna 20 via a matching element 90. As shown in FIG. 1b, the filters 326 and 346 are usually BAW filters. It should be noted that the duplexer can also be a ceramic duplexer. However, it is not possible to have a balun 332 in the Rx branch of a ceramic duplexer. This implies that, to implement both CDMA1900 and CDMA2000 in a front-end according to the US W-CDMA standard, two duplexers are required in addition to the antenna switch module. Also, it would require using one PA to amplify both the CDMA1900 and GSM1900 bands, which is currently impossible.

The drawbacks of the prior art architecture, where one antenna is used for the GSM mode and another is used for the W-CDMA mode, are the inflexibility of the architecture, and more importantly, the difficulty in implementing more than one CDMA (or W-CDMA) in one mobile phone. In order to overcome these drawbacks, it is possible to allow the GSM mode and the W-CDMA mode to share a common antenna and to use switches to select between the modes. However, because of the non-linear behavior of the switches, the Rx is desensitized by mixing products arising from the Tx mixed with a blocking signal from the antenna, as shown in FIGS. 2a and 2b.

It is advantageous and desirable to provide a front-end architecture combining the GSM and W-CDMA modes without the product mixing problems.

### SUMMARY OF THE INVENTION

The present invention uses the combination of filters and switches to solve the non-linearity problems in the GSM/W-CDMA transceiver front-end where one common antenna is used for both the GSM mode and the W-CDMA mode. The present invention makes use of separate Rx/Tx paths and switches in the RX paths to provide sufficient cross-band isolation between bands. An example of cross-band isolation is shown in FIG. 3a.

The present invention is applicable in cellular multimode/multiband phones for US and European standards. It is also applicable to MIMO (multiple input multiple output) transceivers or diversity receivers that may require duplicate Rx-paths for several bands (e.g., 1800/1900GSM and W-CDMA).

Thus, the first aspect of the present invention provides a method for selecting a frequency band in a multiband communications device, the communications device having one or more antennas for conveying radio frequencies, and a front-end module having one or more nodes operatively connected to said one or more antennas, the front end module comprising:
a first bandpass filter disposed in a first signal path for filtering signals in a first frequency band, the first bandpass filter having a first end and a second end, the first end operatively connected to said one or more antennas; and
a second bandpass filter disposed in a second signal path for filtering signals in a second frequency band different from the first frequency band; the second bandpass filter operatively connected to said one or more antennas. The method comprises:
disposing a switch at the second end of the first bandpass filter independent of the second signal path for enabling or disabling the first signal path.

According to the present invention, the first signal path comprises a transmit path and the second signal path comprises a receive path, said method further comprising:
disposing a matching element between the first end of the first bandpass filter and said one or more antenna.

According to the present invention, the first signal path comprises a first receive path and the second signal path comprises a second receive path, and wherein the second bandpass filter has a first end and a second end, the first end of the second bandpass filter operatively connected to said one or more antennas, said method further comprising:
disposing a further switch at the second end of the second bandpass filter for enabling or disabling the second signal path.

According to the present invention, the method further comprises:
operatively connecting a balun to said one or more antennas, so as to allow both the first end of the first bandpass filter and the first end of the second bandpass filter to operatively connect to said one or more antennas via the balun.

The second aspect of the present invention provides a transceiver for use in a communication device having one or more antennas for conveying radio frequency signals. The transceiver comprises:
a first bandpass filter disposed in a first signal path for filtering signals in a first frequency band, the first bandpass filter having a first end and a second end, the first end operatively connected to said one or more antennas;
a second bandpass filter disposed in a second signal path for filtering signals in a second frequency band different from the first frequency band; the second bandpass filter operatively connected to said one or more antennas; and
a switch disposed at the second end of the first bandpass filter independent of the second signal path for enabling or disabling the first signal path.

According to the present invention, the transceiver further comprises:
a matching element disposed between the first end of the first bandpass filter and said one or more antenna.

According to the present invention, the first signal path comprises a transmit path and the second signal path comprises a receive path.

According to the present invention, the first signal path comprises a first receive path and the second signal path comprises a second receive path, and wherein the second bandpass filter has a first end and a second end, the first end of the second bandpass filter operatively connected to said one or more antennas, said transceiver further comprising:
a further switch disposed at the second end of the second bandpass filter for enabling or disabling the second signal path.

According to the present invention, the transceiver further comprises:
a balun operatively connected to said one or more antennas, and both the first end of the first bandpass filter and the first end of the second bandpass filter are operatively connected to said one or more antennas via the balun.

The balun has a first balun end and a second balun end, the first balun end connected to said one or more antennas, the second balun end connected to the first end of the first filter and wherein the second balun end is also connected to the first end of the second filter, the transceiver further comprising:
a second switch disposed in the second receive path and operatively connected to the second end of the second filter.

The first frequency band has a frequency range substantially between 1805 MHz and 1880 MHz, and
the second frequency band has a frequency range substantially between 1930 MHz and 1990 MHz.

Alternatively, the first frequency band has a frequency range substantially between 869 MHz and 894 MHz, and the second frequency band has a frequency range substantially between 925 MHz and 960 MHz.

According to the present invention, the transceiver further comprises:
a matching element operatively connected to said one or more antennas;
a third bandpass filter disposed in a transmit path for filtering signals in a third frequency band, the third bandpass filter having a first end and a second end, the first end operatively connected to the matching element; and
a third switch disposed in the transmit path and operatively connected to the second end of the third bandpass filter.

The third frequency band has a frequency range substantially between 824 MHz and 849 MHz.

Alternatively, the third frequency band has a frequency range substantially between 880 MHz and 905 MHz.

According to the present invention, the transceiver further comprises:
a matching element operatively connected to said one or more antennas;
a third bandpass filter disposed in a transmit path for filtering signals in a third frequency band, the third bandpass filter having a first end and a second end, the first end operatively connected to the matching element; and
a third switch disposed in the transmit path and operatively connected to the second end of the third bandpass filter.

The third frequency band has a frequency range substantially between 1710 MHz and 1785 MHz.

Alternatively, the third frequency band has a frequency range substantially between 1850 MHz and 1910 MHz.

According to the present invention, the transceiver further comprises:
a further matching element operatively connected to said one or more antennas;
a fourth bandpass filter disposed in a further transmit path for filtering signals in a fourth frequency band, the fourth bandpass filter having a first end and a second end, the first end operatively connected to the further matching element; and
a fourth switch disposed in the further transmit path and operatively connected to the second end of the fourth bandpass filter.

The third frequency band has a third frequency range substantially between 1710 MHz and 1785 MHz, and the fourth frequency range substantially between 1850-1910 MHz.

Alternatively, the third frequency band has a third frequency range substantially between 1920 MHz and 1980 MHz, and the fourth frequency range substantially between 1710-1910 MHz.

According to the present invention, the transceiver further comprises:
a further balun; and
a fifth bandpass filter disposed in another receive path for filtering signals in a fifth frequency band, the fifth bandpass filter operatively connected to said one or more antennas via the further balun, wherein the fifth frequency band has a frequency range substantially between 2110 MHz and 2170 MHz.

According to the present invention, the transceiver further comprises:
a further balun; and
a fifth bandpass filter disposed in another receive path for filtering signals in a fifth frequency band, the fifth bandpass filter operatively connected to said one or more antennas via the further balun, wherein the fifth frequency band has a frequency range substantially between 2110 MHz and 2170 MHz.

According to the present invention, the transceiver is operated in a first mode in code-division multiplex access fashion and a second mode in GSM, and the transceiver further comprises:
a first amplifier for amplifying signals in the first mode;
a second amplifier for amplifying signals in the second mode; and
a group of further switches including a first, a second, a third and a fourth further switches, each having a first end and a second end, wherein
   the first end of the first further switch is operatively connected to the transmit path, and the second end of the first further switch is operatively connected to the first amplifier;
   the first end of the second further switch is operatively connected to the transmit path, and the second end of the second further switch is operatively connected to the second amplifier;
   the first end of the third further switch is operatively connected to the further transmit path, and the second end of the third further switch is operatively connected to the first amplifier; and
   the first end of the first further switch is operatively connected to the further transmit path, and the second end of the fourth further switch is operatively connected to the second amplifier.

According to the present invention, the transceiver further comprises:
a matching element disposed between said one or more antennas and the balun, the matching element having a first matching element end connected to said one or more antenna and a second matching element end connected to the balun; and
a further balun disposed between the matching element and the second bandpass filter, the further balun having a first balun end connected to the second matching element end and a second balun end connected to the second bandpass filter.

The first frequency band has a first frequency range substantially between 1930 MHz and 1990 MHz, and the second frequency band has a second frequency range substantially between 2110 MHz and 2170 MHz.

According to the present invention, the transceiver further comprises:
a second matching element;
a third bandpass filter disposed in a transmit path for filtering signals in the third frequency band, the third bandpass filter having a first end and a second end, the first end operatively connected to said one or more antennas through the second matching element; and
a second switch connected to the second end of the third bandpass filter.

According to the present invention, the transceiver further comprises:
a third matching element;
a fourth bandpass filter disposed in a further transmit path for filtering signals in the fourth frequency band, the fourth bandpass filter having a first end and a second end, the first end operatively connected to said one or more antennas through the third matching element; and
a second switch connected to the second end of the fourth bandpass filter.

The first frequency band has a first frequency range substantially between 1930 MHz and 1990 MHz;
the second frequency band has a second frequency range substantially between 2110 MHz and 2170 MHz;
the third frequency band has a third frequency range substantially between 1710 MHz and 1785 MHz; and
the fourth frequency band has a fourth frequency range substantially between 1850 MHz and 1910 MHz.

The third aspect of the present invention provides a communications device comprising:
one or more antennas for conveying radio frequency signals; and
a transceiver, wherein the transceiver comprises:
   a first bandpass filter disposed in a first signal path for filtering signals in a first frequency band, the first bandpass filter having a first end and a second end, the first end operatively connected to said one or more antennas;
   a second bandpass filter disposed in a second signal path for filtering signals in a second frequency band different from the first frequency band; the second bandpass filter operatively connected to said one or more antennas; and
   a switch disposed at the second end of the first bandpass filter independent of the second signal path for enabling or disabling the first signal path.

According to the present invention, the transceiver further comprises:
a matching element disposed between the first end of the first bandpass filter and said one or more antenna.

The first signal path comprises a transmit path and the second signal path comprises a receive path.

Alternatively, the first signal path comprises a first receive path and the second signal path comprises a second receive path, and wherein the second bandpass filter has a first end and a second end, the first end of the second bandpass filter operatively connected to said one or more antennas, said transceiver further comprising:
a further switch disposed at the second end of the second bandpass filter for enabling or disabling the second signal path.

According to the present invention, the transceiver further comprises a balun operatively connected to said one or more antennas, and both the first end of the first bandpass filter and the first end of the second bandpass filter are operatively connected to said one or more antennas via the balun.

According to the present invention, the balun has a first balun end and a second balun end, the first balun end connected to said one or more antennas, the second balun end connected to the first end of the first filter and wherein the second balun end is also connected to the first end of the second filter, wherein the transceiver further comprises:
a second switch disposed in the second receive path and operatively connected to the second end of the second filter.

According to the present invention, the communications device can be a mobile terminal, a communicator device or the like.

The present invention will become apparent upon reading the description taken in conjunction with FIGS. 3a to 9.

### BRIEF DESCRIPTION OF THE DRAWINGS

FIG. 1a is a circuit diagram illustrating the GSM part of a prior art front-end module.

FIG. 1b is a circuit diagram illustrating the W-CDMA part of the same prior art front-end module of FIG. 1a.

FIG. 2a is a circuit diagram illustrating product mixing in a front-end having one antenna connected to both transmission paths and reception paths.

FIG. 2b is a circuit diagram illustrating product mixing in a front-end having one antenna for transmission and one antenna for reception.

FIG. 3a is a schematic representation showing the Tx-Rx antenna isolation in GSM/W-CDMA front-end, according to the present invention.

FIG. 3b is a frequency chart showing the overlapping in GSM and W-CDMA frequencies.

FIG. 4 is a circuit diagram illustrating a European GSM/W-CDMA front-end, according to the present invention.

FIG. 5 is a circuit diagram illustrating a US GSM/W-CDMA front-end, according to the present invention.

FIG. 6 is a circuit diagram illustrating a switched duplexer, according to the present invention.

FIG. 7 is a circuit diagram illustrating a front-end module having multiband GSM antenna switch modules and a W-CDMA duplexer, according to the present invention.

FIG. 8 is a plot showing the responses of the GSM Tx and W-CDMA Tx branches when the shunt switch at the GSM filter output is biased “on”.

FIG. 9 is a plot showing the responses of the GSM Tx and W-CDMA Tx branches when the shunt switch at the W-CDMA filter output is biased “on”.

FIG. 10 is a schematic representation illustrating a communication device having a transceiver front-end, according to the present invention.

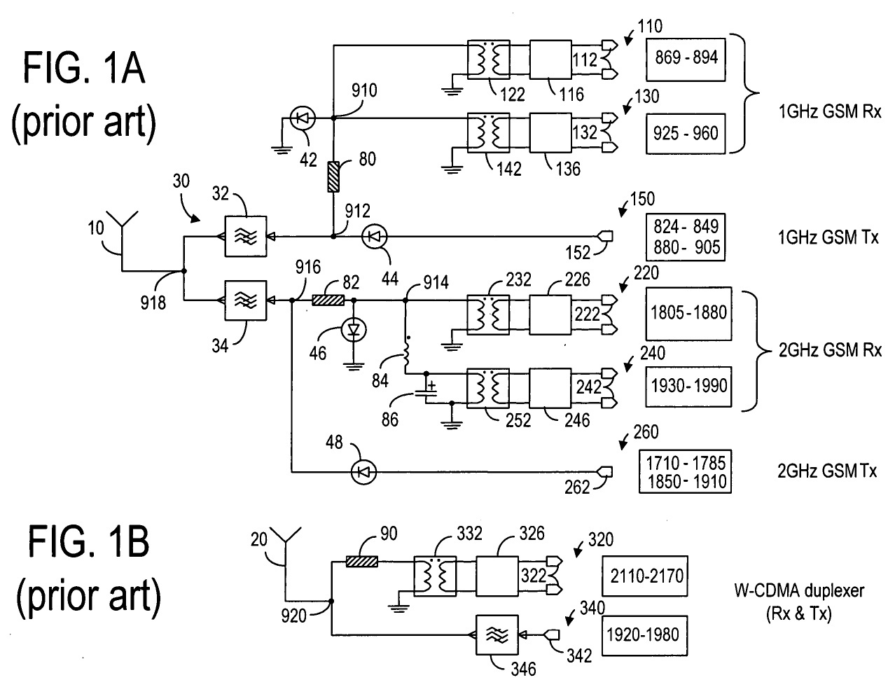

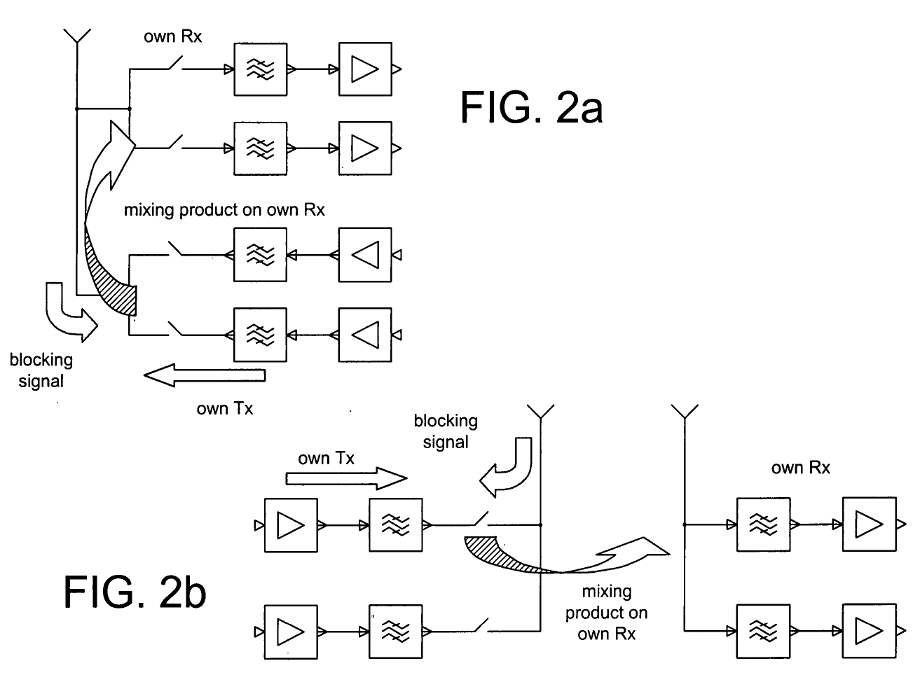

### DETAILED DESCRIPTION OF THE INVENTION

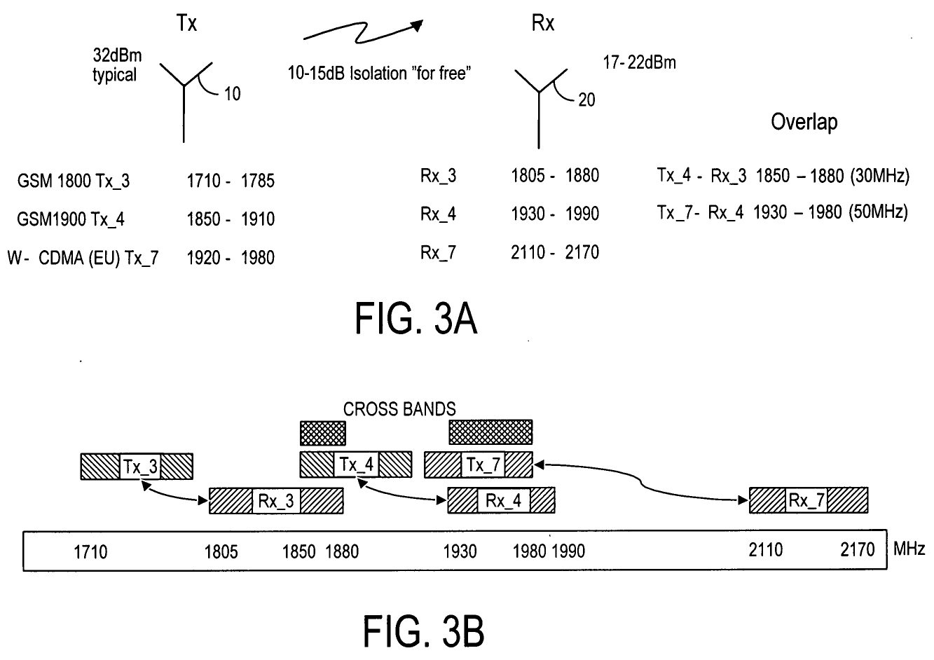

The present invention makes use of separate Rx/Tx paths and switches in the RX paths to provide sufficient cross-band isolation between bands. An example of cross-band isolation is shown in FIG. 3a. As shown in FIG. 3a, the upper band Tx chain connected to the antenna 10 includes 1800GSM Tx_{—}3 (1710-1785 MHz): 1900GSM Tx_{—}4 (1850-1910 MHz) and W-CDMA (EU) Tx_{—}7 (1920-1980 MHz), and the upper band Rx chain connected to the antenna 20 includes 1800GSM Rx_{—}3 (1805-1880 MHz), 1900GSM Rx_{—}4 (1930-1990 MHz) and W-CDMA (EU) Rx_{—}7 (2110-2170 MHz). Thus, the frequency overlap in these chains is: Tx_{—}4-Rx_{—}3 (30 MHz, from 1850 to 1880 MHz), and Tx_{—}7-Rx_{—}4 (50 MHz, from 1930 to 1980 MHz). The cross band problems are also illustrated in FIG. 3b. If the maximum output power at the antenna in Tx mode is 30 to 33 dBm (depending on system standard) and a typical isolation that can be achieved between two separate antennas is between 10 to 20 dBm, for example, then the power level at the Rx antenna is from 13 to 23 dBm. In such a case, the antennas do provide some free Tx to Rx isolation, but for the cross-band this is not sufficient, since a typically acceptable maximum power level at the RF-ASIC input (Rx path) is around 0 dBm during Tx time slot (i.e. LNAs in ASIC are off). Therefore, some means of providing additional attenuation in these cross band cases is needed.

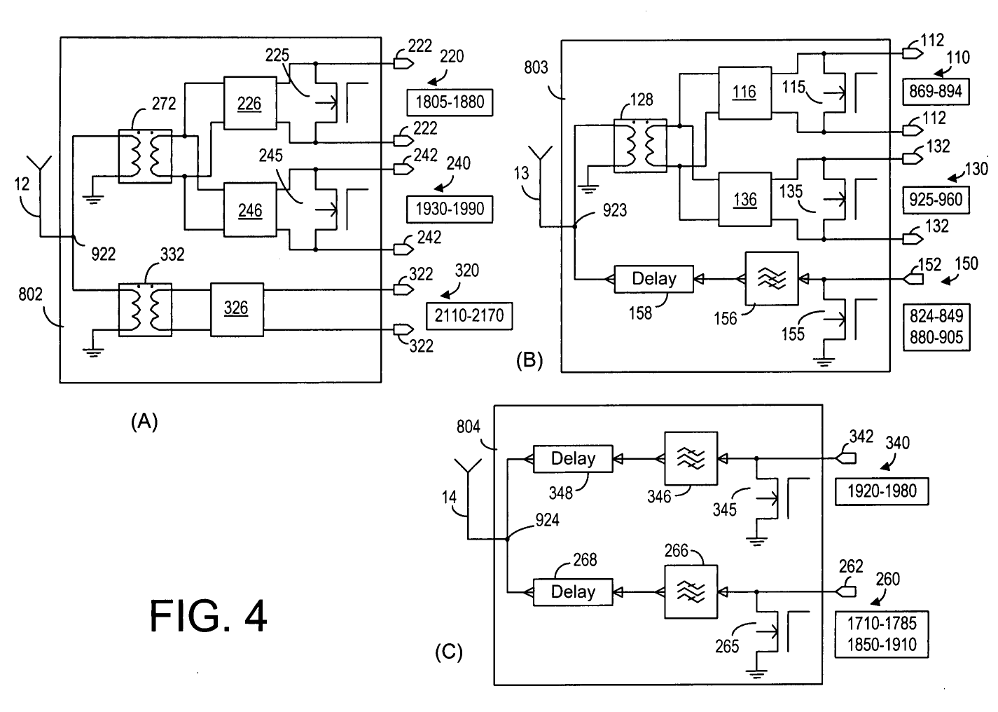

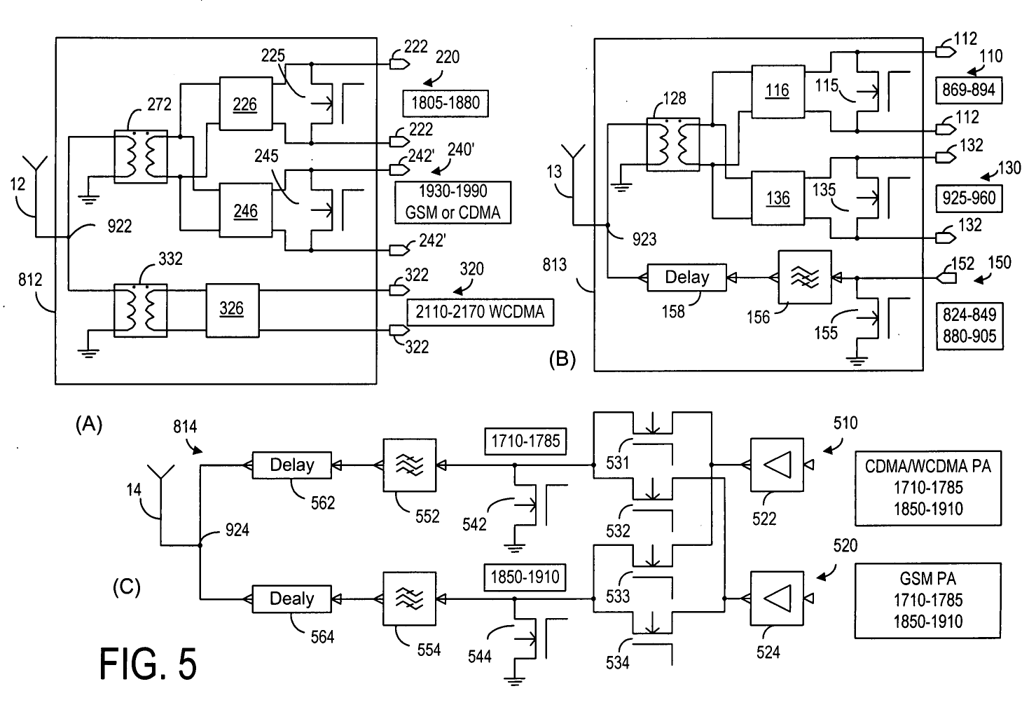

The present invention provides a topology to improve the upper band (2 GHz) Rx and Tx performance and to improve the “universality” of the front-end, using the fact that many of the U.S. and European standards share the same frequencies. The topology is illustrated in two embodiments as shown in FIG. 4 and FIG. 5. FIG. 4 illustrates an embodiment of a European front-end, according to the present invention. FIG. 5 illustrates an embodiment of a U.S. front-end, according to the present invention. For illustration purposes, the European front-end is shown in three separate blocks in FIGS. 4a to 4c. Likewise, the US front-end is shown in three separate blocks in FIGS. 5a to 5c. While the separate blocks in each embodiment can be implemented as one module or parts of some larger modules, separate blocks provide the benefit of flexibility. For example, the 2 GHz Tx and the 1 GHz part can be physically part of a PA (power amplifier), and the 2 GHz Rx parts can be implemented on an RF-backend IC.

The European front-end is an example of a universal front-end in an engine with four GSM bands and the EU W-CDMA: The four GSM bands are:
1) GSM900 (Tx 880-905 MHz and Rx 925-960 MHz);
2) GSM850 (Tx 824-849 MHz and Rx 869-894);
3) GSM 1800 (Tx 1710-1785 MHz and Rx 1805-1880 MHz) and
4) GSM1900 (Tx 1850-1901 MHz and Rx 1930-1990 MHz).
   The EU W-CDMA occupies the frequencies of (Tx 1920-1980 MHz and Rx 2110-2170 MHz).

To provide flexibility to the topology, the European front-end is illustrated as separated into three blocks 802, 803 and 804, separately depicted in FIGS. 4a, 4b and 4c. The block 802, as shown in FIG. 4a, comprises the 2 GHz GSM Rx paths 220 and 240 and a W-CDMA Rx path 320. All these paths are connected to a common node 922 and a common antenna 12. The paths 220 and 240 share a common balun 272 through separate filters 226 and 246, respectively. The path 220 has a shunt switch 225 connected between the ports 222 and the filter 226. The path 240 has a shunt switch 245 connected between the ports 242 and the filter 246. It should be noted that the filters 226 and 246 are disposed between the respective switches 225, 245 and the antenna 12. The switches 225 and 245 are used to enable or disable the 2 GHz GSM paths. The path 320 has a balun 332 and a filter 326 disposed between the ports 322 and the common node 922. All the filters 226, 246 and 326 are balanced filters.

The block 803, as shown in FIG. 4b, comprises the 1 GHz GSM Rx paths 110 and 130 and a 1 GHz Tx path 150. All these paths are connected to a common node 923 and a common antenna 13. The paths 110 and 130 share a common balun 128 through separate filters 116 and 136, respectively. The path 110 has a shunt switch 115 connected between the ports 112 and the filter 116. The path 130 has a shunt switch 135 connected between the ports 132 and the filter 136. It should be noted that the filters 116 and 136 are disposed between the respective switches 115, 135 and the antenna 13. The switches 115 and 135 are used to enable or disable the 1 GHz GSM paths. The path 150 has a delay 158 and a filter 156 disposed between the ports 152 and the common node 923. Thee filters 116 and 136 are balanced filters, whereas the filter 156 is a single-end filter.

The block 804, as shown in FIG. 4c, comprises a 2 GHz GSM Tx path 260 and a W-CDMA Tx path 340. These two paths are connected to a common node 924 and a common antenna 14. The path 340 has a single-end filter 346 and a delay 348 between the single port 342 and the common node 924. The path 260 has a single-end filter 266 and a delay 268 between the single port 262 and common node 924. For path selection, the path 330 has a switch 345 disposed between the port 342 and the filter 346, and the path 260 has a switch 265 disposed between the port 262 and the filter 266.

The delays 158, 348 and 268 are used for Tx filter matching.

To provide flexibility to the topology, the U.S. front-end is also illustrated as separated into three blocks 812, 813 and 814, separately depicted in FIGS. 5a, 5b and 5c. The block 812, as shown in FIG. 5a, comprises the 2 GHz GSM Rx paths 220 and 240′ and a W-CDMA Rx path 320. The path 240′ is also used as the Rx path for 1900CDMA, which is also known as U.S. W-CDMA (US1) (1930-1990 MHz). All these paths are connected to a common node 922 and a common antenna 12. The paths 220 and 240′ share a common balun 272 through separate filters 226 and 246, respectively. The path 220 has a shunt switch 225 connected between the ports 222 and the filter 226. The path 240′ has a shunt switch 245 connected between the ports 242′ and the filter 246. It should be noted that the filters 226 and 246 are disposed between the respective switches 225, 245 and the antenna 12. The switches 225 and 245 are used to enable or disable the 2 GHz GSM or 1900CDMA paths. The path 320 has a balun 332 and a filter 326 disposed between the ports 322 and the common node 922. The block 812 is essentially identical to the block 802 in the European counter.

The block 813, as shown in FIG. 5b, is identical to the block 803, as shown in FIG. 4b.

The block 814, as shown in FIG. 5c, comprises two Tx paths 510 and 520. However, path 340 and path 260 in block 804 of the European front-end, are used for Tx signals in different frequency ranges. The two Tx paths 510 and 520 are used for the same frequency ranges but for different modes. The path 510 has a PA 522 for the CDMA/W-CDMA mode (US2 Tx: 1710-1785 MHz; and US1 Tx: 1850-1910 MHz). The path 520 has a PA 524 for the 2 GHz Tx. For selecting between (1710-1785 MHz) and (1850-1910 MHz), each of the paths 510 and 520 has two switches (531, 532) and (533, 534). After this switching stage, the 1800 (1710-1785 MHz) branch is connected to a common node 924 through a passband filter 552 and a delay 562. The 1900 (1850-1910 MHz) branch is connected to the common node 924 through a passband filter 554 and a delay 564. For branch selection, the 1800 branch has a switch 542 and the 1900 branch has a switch 544. It should be noted that all the switches are disposed further from the antenna 14 than the filters 552, 554. No switches are disposed between the filters 552, 554 and the antenna 14.

The present invention also makes use of three facts:

1) Two filters close in frequency can be matched to a common node virtually without degradation in performance, even if the separating switch is only located at the output end of the filters (i.e. the filters remain connected to the common node at all times). This is possible when the phase shift through the filter from the common node to the shunt switch is a multiple of 90 degrees (e.g. 90 or 270) or even a multiple of 180 degrees in case of series switch. In practice the path in the “off” state looks like an open circuit from the common node. This is especially important in the case where the pass bands of the selective (WCDMA or CDMA) Tx filter overlap that of the less selective GSM Tx filter. If both of the Tx filters that are to be switched are highly selective and do not overlap, then the phase shift is more just a matching network and does not necessarily need to be exactly 90 degrees. The fact is demonstrated by the switches 225 and 245 in FIG. 4a, wherein the switches are implemented on the output sides of the filters 226 and 246, respectively. This fact is further demonstrated in FIG. 4b where the switches 115, 135 and 155 are located on the far side of the filters 116, 136 and 156, respectively, in reference to the antenna 13.

2) By utilizing band pass filters in the Tx part of any CDMA or W-CDMA transmit path where the switch (either in series or shunt) is disposed between the PA and the filter, the blocking signals entering from the antenna will not be able to propagate to the switch because of the selective filter. Therefore, no mixing products will be generated. The switch only needs to be linear enough not to generate too much power on the adjacent channels. This fact is demonstrated in FIG. 5c, where the switches 531, 533, 542 and 544 are disposed between the CDMA/W-CDMA PA 552 and the filters 552 and 554 the transmitted paths 510 and 520.

3) As several of the US and EU bands share either the same Tx or Rx, by proper switching, the number of needed filters will be smaller than the number of standards that can be supported. For example, the Rx path 552 in FIG. 5c can be used for both the 2 GHz GSM and US2 Tx, US1 Tx.

By combining these facts, a very portable and universal front-end can be designed, although the basic principle can be utilized also to create, for example, a duplexer that supports two Tx and two Rx frequencies and includes a switch at least in the Tx paths.

By comparing the EU front-end as shown in FIG. 4 and the U.S. front-end as shown in FIG. 5, it can be seen that the difference between the two front-ends is mainly in the 2 GHz Tx part (FIG. 4c and FIG. 5c). Thus, in order to make a similar engine for the U.S. market, only a small modification to the EU front-end in the 2 GHz Tx part is required. With this modification, one has an option of also including the new US WCDMA bands (Tx 1710-1785 MHz and Rx Rx 2110-2170 MHz). Furthermore, the Rx filter 246 (FIGS. 4a and 5a) at 1930-1990 MHz can be used for both the GSM1900 Rx and the CDMA1900 Rx, if properly designed. Similarly, the Tx filter 552 (FIG. 5c) for GSM 1800 can also be used for the US WCDMA (US2) and the Tx filter 554 in the 1900 branch can be used for both the GSM1900 Tx and CDMA1900 Tx (US1) through different PAs 552, 554. As a result, only three Rx filters (226, 246, 326 in FIGS. 4a and 5a) and only two Tx filters (552, 554 in FIG. 5c) are needed for the four standards (GSM1800&1900 and CDMA/WCDMA) supported at 2 GHz.

The present invention as disclosed herein is described in terms of European GSM and W-CDMA standards, but the concepts are also applicable for more US-emphasized band combinations. The disclosure is also based on the assumption that that the Rx bands should have differential outputs, and the Tx bands should be single ended, but the concepts are also valid for either single-ended Rx or even differential Tx. Furthermore, the switches referred to in this disclosure can be of any type, i.e. PIN diodes, GaAs P- HMETs, CMOS or even MEMS. Similarly, the selective filters can be SAW filters (either single to balanced or fully balanced), or they can be BAWs (again either fully balanced or filters that incorporate an acoustic balun), the baluns can be integrated or discrete magnetic baluns, transmission line based baluns or even L/C baluns. Thus, the embodiments described herein are relevant to a general topology of the present invention. The disclosed embodiments should not be construed as being achievable only by a certain technology.

The various aspects of the present invention are illustrated in FIGS. 4 and 5.

FIG. 4 represents a possible novel front-end design according the present invention, which includes the four GSM bands and the European WCDMA. The design assumes separate Tx and Rx antennas 12, 14 for the 2 GHz bands and one common Tx/Rx antenna 13 for the 1 GHz. This is, however, not a prerequisite for the invention. At 2 GHz, the separate Tx and Rx antennas 12, 14 are used to relax some of the Tx to Rx isolation requirements and such implemention is preferable from a filter design point of view. At 1 GHz, there is only one common antenna 13. The antenna 13 is physically the largest among the three antennas. In a modern cellular phone, it is impractical to have two separate antennas for 1 GHz.

It should be noted that, as shown in FIGS. 4a to 5c, all of the switches are implemented such that the filters are located between the switches and the antennas. Such implementation is one of the important features in the front-end design, according to the present invention.

It should also be noted that band pass filters can be matched to one common node even if they are only disconnected at the outputs, as long as the impedance at the output can be controlled (i.e. it is 50 Ohms, short or open). In the case of the EU front-end as shown in FIG. 4, the 2 GHz GSM filter 266 can basically be only a harmonic notch filter without very much selectivity close to the actual Tx bands, whereas the WCDMA Tx filter 346 needs to be very selective in order to provide high attenuation at the WCDMA Rx band (path 320). If these filters were only passively matched to the common node 924, the WCDMA Tx in path 340 would see through the GSM filter 266. As a result, not all the power would be available at the antenna 14. The combination of the GSM filter 266 with a switch 265 at the output needs to present an “open circuit” to the common node 924 when the WCDMA Tx path 340 is used. This can be achieved by using delays as shown in FIG. 4 where the phase delay through the GSM is 90 degrees or an odd multiple thereof. As such, when the GSM switch 265 is biased to “on” during the WCDMA operation, the impedance of the short-circuited switch is transformed to a very high impedance at the common node 924. For the GSM operation, the switches are biased so that the shunt switch 345 at the output of WCDMA filter 346 is biased “on”. This in turn makes the WCDMA filter 346 electrically almost invisible for the GSM Tx signal.

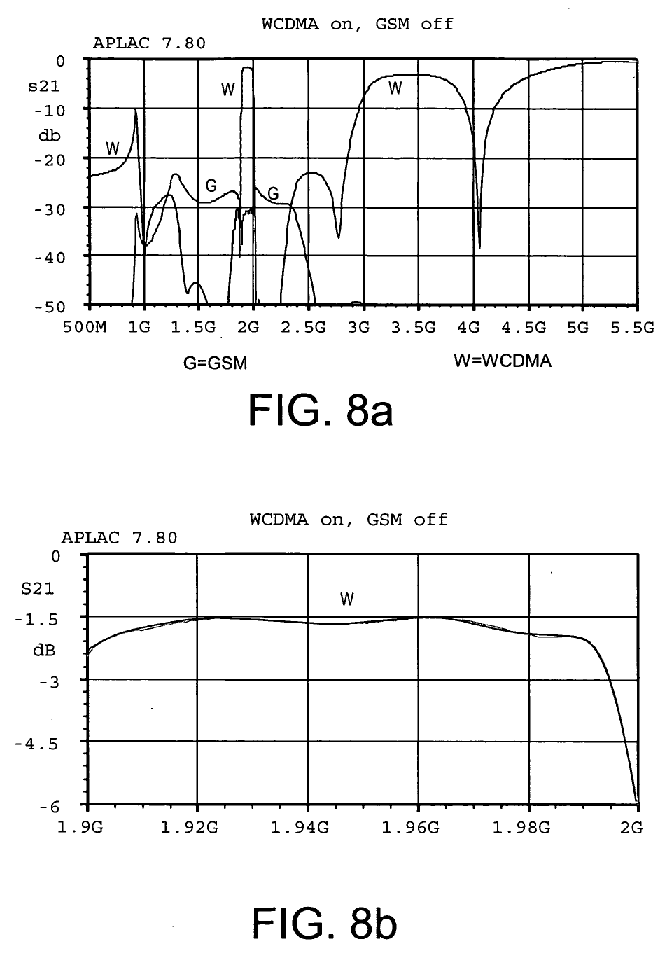

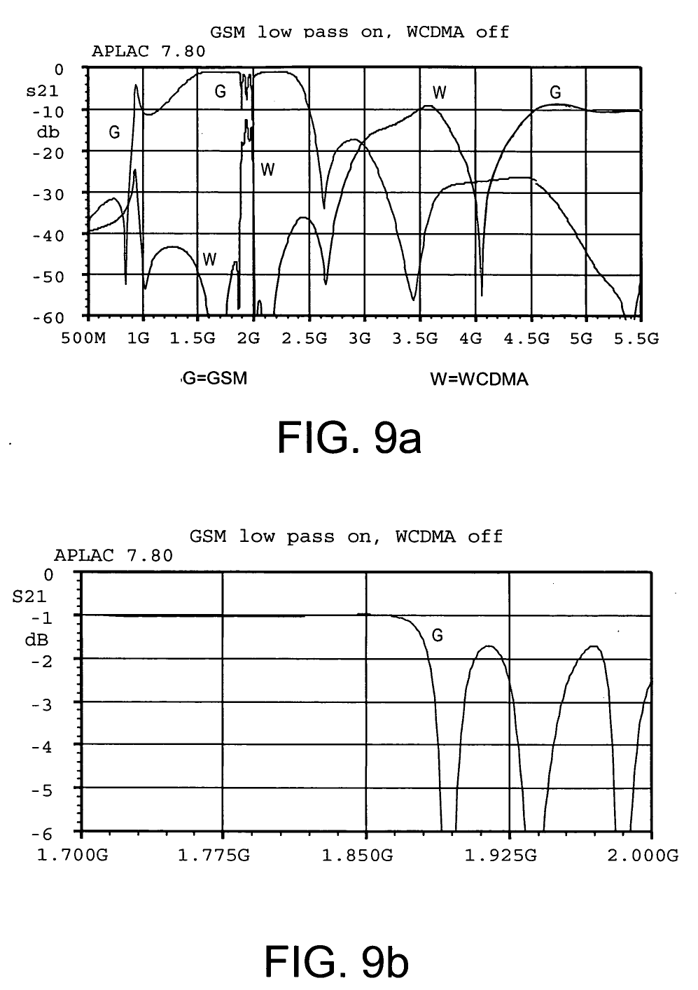

It should be noted that the switches can also be configured into a series connection. In this case the phase delay through the filter+matching network should be an even multiple of 180 degrees. Alternatively, one can also have both series and shunt switches, as long as the filters are properly matched. In this case, the problem of a blocking signal mixing with its own Tx signal (generally only a problem in the CDMA and W-CDMA standards) can be solved since only the signals at the Tx frequency can enter the switch from antenna. Accordingly, these signals would mix to DC, but not with its own Rx band. Exemplary responses of the GSM and WCDMA paths with different switches being “on” are shown in FIGS. 8a-9b. FIGS. 8a and 8b show the W-CDMA and GSM responses at different scales when the shunt switch 265 at the GSM filter 266 is biased “on”. FIGS. 9a and 9b show the W-CDMA and GSM responses at different scales when the shunt switch 345 at the W-CDMA filter 346 is biased “on”. Even though each of the Tx paths is shown with a delay (=phase shifter) and the filter, in practice, the filter and the matching elements can be design so that the phase shifter is included in the filter itself. The separate delays are shown to emphasize that a certain phase delay through each tx path at the center frequency needs to be achieved.

It should also be noted that, in FIGS. 4a and 4b, the shunt switches 115, 135, 155, 225, 245 at the outputs of the Rx-filters 116, 136, 156, 226, 246. The separate Rx and Tx antennas together with the steep Rx filters provide enough Tx to Rx isolation, rendering any additional Tx/Rx switching for a given band, in principle, unnecessary. However, the problem of cross-band isolation still needs to be solved.

The problem of cross-band isolation arises from the fact that, even though the Tx and Rx bands of a given standard do not overlap, there may be (and usually are) Tx frequencies in a multiband engine that overlap with other Rx frequencies. Moreover, there are also out of band blocking signals that need to be attenuated. For example, in the GSM 1900 standard, the Tx frequencies range from 1850 to 1910 MHz and the corresponding Rx range from 1930 to 1990 MHz. In that case, the Tx and Rx bands are separated by 20 MHz. However, this Tx band does partially overlap with the GSM 1800 Rx, which is at 1805 to 1880 MHz. This implies that although the signal from the Tx antenna can be correctly attenuated in the GSM 1900Rx filter, it will be able to pass through the GSM 1800 Rx filter. From the system point of view this is problematic because the next element in the Rx chain is usually an LNA (low noise amplifier), which is already integrated into the RF-ASIC. Even when the LNA for the 1800GSM is in the “off” state, fairly high signal levels of the 1800GSM may exist in the bond wires and cause interference in the operation of the RF-ASIC. This is especially true for modern RF-ASIC that operates on very low supply voltages like 1.2V. A high level input signal may even damage the RF-ASIC. The only attenuation in these cross-band situations is provided by the separate antennas and this is typically only around 10 to 15 dB, which is not enough. These potential cross band frequencies are shown in FIG. 3 for the case 1800, 1900GSM and the European W-CDMA.

It should also be noted that the separate antennas do not significantly help against out-of-band blocking signals that enter the Rx antenna during the Rx mode. These signals are typically attenuated by the corresponding Rx filter (the very reason for the Rx filter). If there is another Rx filter in shunt, this filter allows blocking signals on its passband to propagate to the RF-ASIC. To solve this problem LNAs that are not integrated to the RF-ASIC can be used. Alternatively, switches can be disposed at the input of the filters. Such placement of switches would make the matching a bit easier. Unfortunately, the mixing products could turn out to be a problem.

To solve the problem associated with the out-of-band blocking signals, the present invention places the switches at the output of the filters, either in shunt as shown in FIG. 4, or in series. The shunt switches can be connected to ground, but it is also enough just to short the balanced output of a filter to achieve very high attenuation, effectively “disconnecting” the filter. As such, shunt switches can be biased “on” to turn “off” the desired filters. In contrast, if series switches are used, they would be biased “on” to turn the respective filter to “on”.

As mentioned earlier, the U.S. front-end as shown in FIG. 5 can be derived from the EU version simply by changing the two 2 GHz Tx filters and their matching elements. The 2 GHz GSM Tx filter 266 in block 804 (FIG. 4c) is replaced by two selective band pass filters 552 and 554, one for the GSM1800 and another for the GSM1900. If these band pass filters are properly designed, they will be able to provide enough attenuation at the corresponding Rx-bands. As such, they can also be used for the CDMA1900Tx and the new US standard (with Tx at 1800 MHz). The switching of the PAs 522 and 524, in this case, significantly depends on the PA architecture. It depends on whether one GSM can be used to amplify all of these bands and modulation types, or whether there are separate (W)CDMA and GSM PAs for better efficiency reasons, for example. However the filters and the first switches (again either in shunt or series) can be used in any case. Similarly the Rx1900 can be designed such that it supports both the GSM1900 and the CDAM1900 requirements.

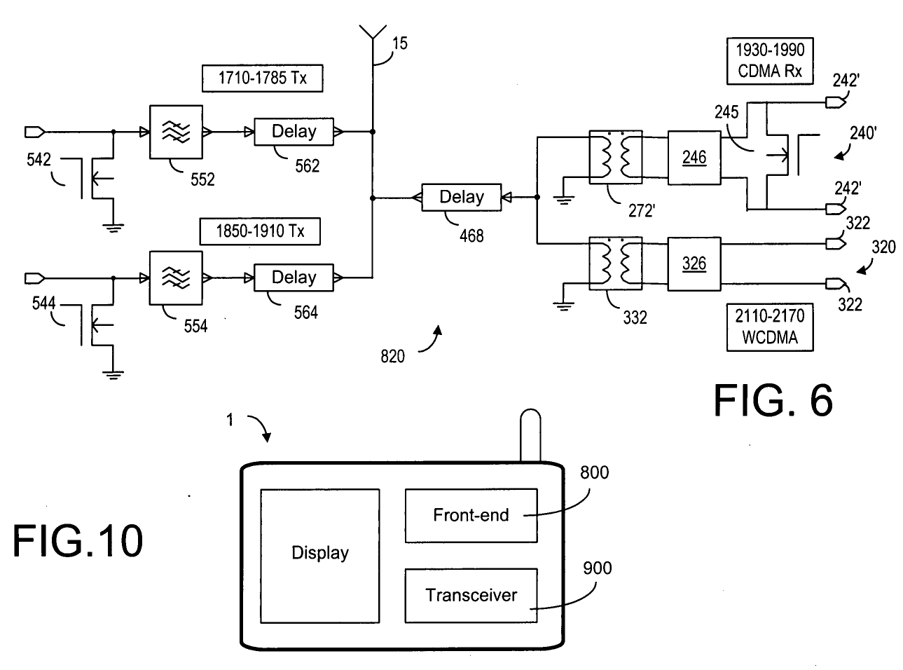

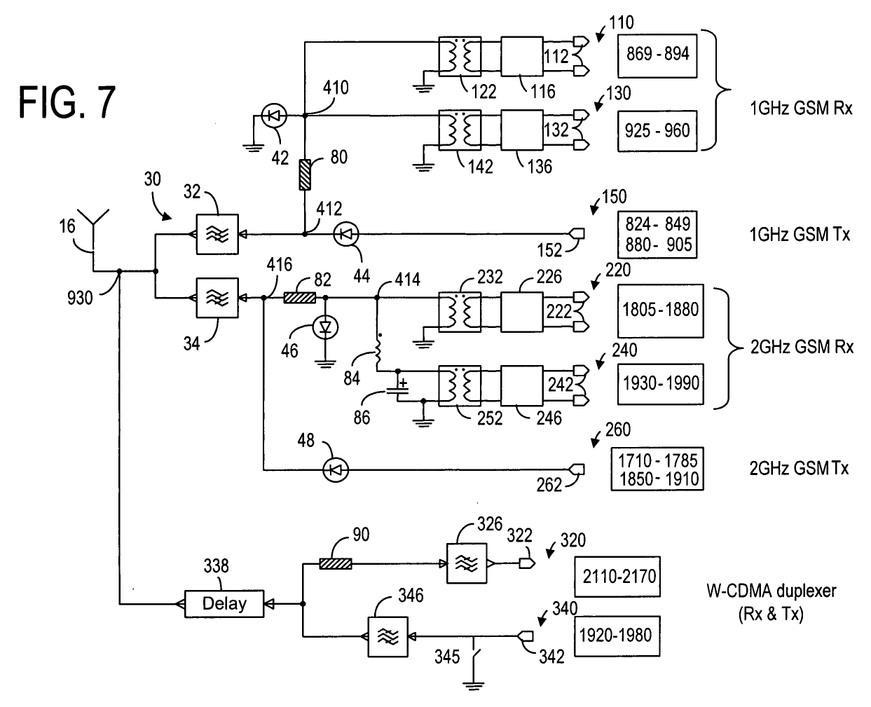

It should be appreciated that FIGS. 4 and 5 are just two embodiments of the present invention, illustrating the principle of how front-ends can be designed with switches being disposed after the filters and with the inputs being matched to one common node. Other embodiments that use the principle of the present invention are shown in FIGS. 6 and 7.

FIG. 6 shows a duplexer 820 wherein a common antenna 15 is used for both Tx and Rx designed to be compatible with the existing type 3 or 4 band GSM antenna switch modules. This duplexer can support even two different frequency ranges. In FIG. 6, all the switches 245, 542 and 544 are placed at the far side of the filters 246, 552 and 554, in reference to the antenna 15.

FIG. 7 is a modification of the conventional front-end that uses a diplexer 30 with harmonic filters for 1 and 2 GHz Tx. As shown in FIG. 7, a switch 345 placed at the far end of the filter 346 is used for switching in the W-CDMA duplexer. The duplexer shares a common node 930 and the antenna 16 with the diplexer 30.

The advantages of the present invention depend on the specific band combination and implementation. In general, one of the major advantages is that the principle, according to the present invention, gives a new option of including and designing front-ends that have WCDMA or CDMA together with GSM bands. Depending on the combination of bands, the present invention also facilitates the “re-use” of filters, i.e. different standards can be supported with the same filter, which, in certain cases, reduces the number of filters needed. As such, the front-end can be simplified and be more cost-effective, compared with existing solutions. The two architectures shown in FIGS. 4 and 5 also, by default, support downlink MIMO and diversity, which can be achieved by simply duplicating the 2 GHz Rx-part.

In order to illustrate the advantages of the present invention, FIG. 8a shows the responses of the GSM Tx and W-CDMA Tx branches when the shunt switch at the GSM filter output is biased “on”. FIG. 8b shows the same response in more detail.

Likewise, FIG. 9a shows the responses of the GSM Tx and W-CDMA Tx branches when the shunt switch at the W-CDMA filter output is biased “on”. FIG. 9b shows the same response in more detail.

One disadvantage associated with the present invention is that the switches in the TX path may increase the losses somewhat, especially in the WCDMA because currently the duplexer has no switches.

The front-end modules as shown in FIGS. 4, 5, 6 and 7 of the present invention, can be used in a communication device, such as a mobile phone or mobile terminal, as shown in FIG. 10. As shown in FIG. 10, the communication device 1 comprises a multiband front-end module 800, which can be any one of the front end modules as shown in FIGS. 5 to 7. The front-end module 800 has a plurality of transmit and receive paths, operatively connected to the transceiver 900.

Although the invention has been described with respect to a preferred embodiment thereof, it will be understood by those skilled in the art that the foregoing and various other changes, omissions and deviations in the form and detail thereof may be made without departing from the scope of this invention.

1. A method for selecting a frequency band in a multiband communications device, the communications device having one or more antennas for conveying radio frequencies, and a front-end module having one or more nodes operatively connected to said one or more antennas, the front end module comprising:
a first bandpass filter disposed in a first signal path for filtering signals in a first frequency band, the first bandpass filter having a first end and a second end, the first end operatively connected to said one or more antennas; and
a second bandpass filter disposed in a second signal path for filtering signals in a second frequency band different from the first frequency band; the second bandpass filter operatively connected to said one or more antennas, said method comprising:
disposing a switch at the second end of the first bandpass filter independent of the second signal path for enabling or disabling the first signal path.

2. The method of claim 1, wherein the first signal path comprises a transmit path and the second signal path comprises a receive path, said method further comprising:
disposing a matching element between the first end of the first bandpass filter and said one or more antenna.

3. The method of claim 1, wherein the first signal path comprises a first receive path and the second signal path comprises a second receive path, and wherein the second bandpass filter has a first end and a second end, the first end of the second bandpass filter operatively connected to said one or more antennas, said method further comprising:
disposing a further switch at the second end of the second bandpass filter for enabling or disabling the second signal path.

4. The method of claim 3, further comprising:
operatively connecting a balun to said one or more antennas, so as to allow both the first end of the first bandpass filter and the first end of the second bandpass filter to operatively connect to said one or more antennas via the balun.

5. A transceiver for use in a communication device having one or more antennas for conveying radio frequency signals, said transceiver comprising:
a first bandpass filter disposed in a first signal path for filtering signals in a first frequency band, the first bandpass filter having a first end and a second end, the first end operatively connected to said one or more antennas;
a second bandpass filter disposed in a second signal path for filtering signals in a second frequency band different from the first frequency band; the second bandpass filter operatively connected to said one or more antennas; and
a switch disposed at the second end of the first bandpass filter independent of the second signal path for enabling or disabling the first signal path.

6. The transceiver of claim 5, further comprising:
a matching element disposed between the first end of the first bandpass filter and said one or more antenna.

7. The transceiver of claim 6, wherein the first signal path comprises a transmit path and the second signal path comprises a receive path.

8. The transceiver of claim 5, wherein the first signal path comprises a first receive path and the second signal path comprises a second receive path, and wherein the second bandpass filter has a first end and a second end, the first end of the second bandpass filter operatively connected to said one or more antennas, said transceiver further comprising:
a further switch disposed at the second end of the second bandpass filter for enabling or disabling the second signal path.

9. The transceiver of claim 8, further comprising a balun operatively connected to said one or more antennas, and both the first end of the first bandpass filter and the first end of the second bandpass filter are operatively connected to said one or more antennas via the balun.

10. The transceiver of claim 9, wherein the balun has a first balun end and a second balun end, the first balun end connected to said one or more antennas, the second balun end connected to the first end of the first filter and wherein the second balun end is also connected to the first end of the second filter, the transceiver further comprising:
a second switch disposed in the second receive path and operatively connected to the second end of the second filter.

11. The transceiver of claim 10, wherein
the first frequency band has a frequency range substantially between 1805 MHz and 1880 MHz, and
the second frequency band has a frequency range substantially between 1930 MHz and 1990 MHz.

12. The transceiver of claim 10, wherein
the first frequency band has a frequency range substantially between 869 MHz and 894 MHz, and
the second frequency band has a frequency range substantially between 925 MHz and 960 MHz.

13. The transceiver of claim 12, further comprising:
a matching element operatively connected to said one or more antennas;
a third bandpass filter disposed in a transmit path for filtering signals in a third frequency band, the third bandpass filter having a first end and a second end, the first end operatively connected to the matching element; and
a third switch disposed in the transmit path and operatively connected to the second end of the third bandpass filter.

14. The transceiver of claim 13, wherein the third frequency band has a frequency range substantially between 824 MHz and 849 MHz.

15. The transceiver of claim 13, wherein the third frequency band has a frequency range substantially between 880 MHz and 905 MHz.

16. The transceiver of claim 11, further comprising:
a matching element operatively connected to said one or more antennas;
a third bandpass filter disposed in a transmit path for filtering signals in a third frequency band, the third bandpass filter having a first end and a second end, the first end operatively connected to the matching element; and
a third switch disposed in the transmit path and operatively connected to the second end of the third bandpass filter.

17. The transceiver of claim 16, wherein the third frequency band has a frequency range substantially between 1710 MHz and 1785 MHz.

18. The transceiver of claim 16, wherein the third frequency band has a frequency range substantially between 1850 MHz and 1910 MHz.

19. The transceiver of claim 16, further comprising:
a further matching element operatively connected to said one or more antennas;
a fourth bandpass filter disposed in a further transmit path for filtering signals in a fourth frequency band, the fourth bandpass filter having a first end and a second end, the first end operatively connected to the further matching element; and
a fourth switch disposed in the further transmit path and operatively connected to the second end of the fourth bandpass filter.

20. The transceiver of claim 19, wherein the third frequency band has a third frequency range substantially between 1710 MHz and 1785 MHz, and the fourth frequency range substantially between 1850-1910 MHz.

21. The transceiver of claim 19, wherein the third frequency band has a third frequency range substantially between 1920 MHz and 1980 MHz, and the fourth frequency range substantially between 1710-1910 MHz.

22. The transceiver of claim 20, further comprising:
a further balun; and
a fifth bandpass filter disposed in another receive path for filtering signals in a fifth frequency band, the fifth bandpass filter operatively connected to said one or more antennas via the further balun, wherein the fifth frequency band has a frequency range substantially between 2110 MHz and 2170 MHz.

23. The transceiver of claim 21, further comprising:
a further balun; and
a fifth bandpass filter disposed in another receive path for filtering signals in a fifth frequency band, the fifth bandpass filter operatively connected to said one or more antennas via the further balun, wherein the fifth frequency band has a frequency range substantially between 2110 MHz and 2170 MHz.

24. The transceiver of claim 22, wherein the transceiver is operated in a first mode in code-division multiplex access fashion and a second mode in GSM, said transceiver further comprising:
a first amplifier for amplifying signals in the first mode;
a second amplifier for amplifying signals in the second mode; and
a group of further switches including a first, a second, a third and a fourth further switches, each having a first end and a second end, wherein
the first end of the first further switch is operatively connected to the transmit path, and the second end of the first further switch is operatively connected to the first amplifier;
the first end of the second further switch is operatively connected to the transmit path, and the second end of the second further switch is operatively connected to the second amplifier;
the first end of the third further switch is operatively connected to the further transmit path, and the second end of the third further switch is operatively connected to the first amplifier; and
the first end of the first further switch is operatively connected to the further transmit path, and the second end of the fourth further switch is operatively connected to the second amplifier.

25. The transceiver of claim 9, further comprising:
a matching element disposed between said one or more antennas and the balun, the matching element having a first matching element end connected to said one or more antenna and a second matching element end connected to the balun; and
a further balun disposed between the matching element and the second bandpass filter, the further balun having a first balun end connected to the second matching element end and a second balun end connected to the second bandpass filter.

26. The transceiver of claim 25, wherein the first frequency band has a first frequency range substantially between 1930 MHz and 1990 MHz, and the second frequency band has a second frequency range substantially between 2110 MHz and 2170 MHz.

27. The transceiver of claim 25, further comprising:
a second matching element;
a third bandpass filter disposed in a transmit path for filtering signals in the third frequency band, the third bandpass filter having a first end and a second end, the first end operatively connected to said one or more antennas through the second matching element; and
a second switch connected to the second end of the third bandpass filter.

28. The transceiver of claim 27, further comprising:
a third matching element;
a fourth bandpass filter disposed in a further transmit path for filtering signals in the fourth frequency band, the fourth bandpass filter having a first end and a second end, the first end operatively connected to said one or more antennas through the third matching element; and
a second switch connected to the second end of the fourth bandpass filter.

29. The transceiver of claim 27, wherein
the first frequency band has a first frequency range substantially between 1930 MHz and 1990 MHz;
the second frequency band has a second frequency range substantially between 2110 MHz and 2170 MHz;
the third frequency band has a third frequency range substantially between 1710 MHz and 1785 MHz; and
the fourth frequency band has a fourth frequency range substantially between 1850 MHz and 1910 MHz.

30. A communications device comprising:
one or more antennas for conveying radio frequency signals; and
a transceiver, wherein the transceiver comprises:
a first bandpass filter disposed in a first signal path for filtering signals in a first frequency band, the first bandpass filter having a first end and a second end, the first end operatively connected to said one or more antennas;
a second bandpass filter disposed in a second signal path for filtering signals in a second frequency band different from the first frequency band; the second bandpass filter operatively connected to said one or more antennas; and
a switch disposed at the second end of the first bandpass filter independent of the second signal path for enabling or disabling the first signal path.

31. The communications device of claim 30, wherein the transceiver further comprises:
a matching element disposed between the first end of the first bandpass filter and said one or more antenna.

32. The communications device of claim 31, wherein the first signal path comprises a transmit path and the second signal path comprises a receive path.

33. The communications device of claim 30, wherein the first signal path comprises a first receive path and the second signal path comprises a second receive path, and wherein the second bandpass filter has a first end and a second end, the first end of the second bandpass filter operatively connected to said one or more antennas, said transceiver further comprising:
a further switch disposed at the second end of the second bandpass filter for enabling or disabling the second signal path.

34. The communications device of claim 33, wherein the transceiver further comprises a balun operatively connected to said one or more antennas, and both the first end of the first bandpass filter and the first end of the second bandpass filter are operatively connected to said one or more antennas via the balun.

35. The communications device of claim 34, wherein the balun has a first balun end and a second balun end, the first balun end connected to said one or more antennas, the second balun end connected to the first end of the first filter and wherein the second balun end is also connected to the first end of the second filter, the transceiver further comprising:
a second switch disposed in the second receive path and operatively connected to the second end of the second filter.

36. The communications device of claim 30, comprising a mobile terminal.
